(19) United States
(12) Patent Application Publication
(10) Pub. No.: US 2025/0043514 A1
(43) Pub. Date: Feb. 6, 2025

(54) METHOD FOR PRODUCING INSULATION PRODUCTS BASED ON MINERAL FIBRES OR ORGANIC FIBRES OF NATURAL ORIGIN

(71) Applicant: SAINT-GOBAIN ISOVER, COURBEVOIE (FR)

(72) Inventor: Arnaud SOISSON, AUBERVILLIERS (FR)

(21) Appl. No.: 18/720,470

(22) PCT Filed: Dec. 15, 2022
(86) PCT No.: PCT/FR2022/052374

§ 371 Date: Jun. 14, 2024

(30) Foreign Application Priority Data
Dec. 17, 2021 (FR) 2113776

(51) Int. Cl. D21H 21/16; D04H 1/26; D04H 1/4218; D04H 1/587; D04H 1/64; D21H 11/00; D21H 13/40; D21H 17/18; D21H 17/53

(52) U.S. Cl. CPC D21H 21/16; D04H 1/26; D04H 1/4218; D04H 1/587; D04H 1/64; D21H 11/00; D21H 13/40; D21H 17/18; D21H 17/53

(57) ABSTRACT

A method for manufacturing an insulation product including mineral fibers or natural organic fibers bound by an organic binder, the method including (a) applying a sizing composition to the mineral fibers or the natural organic fibers, (b) forming an assembly of the mineral fibers or the natural organic fibers, (c) heating the assembly of the mineral fibers or the natural organic fibers until the sizing composition has cured, wherein the sizing composition includes at least one lignin, which is potentially oxidized, and at least one non-polymeric polycarboxylic organic acid.

The present invention relates to a method for manufacturing insulation products comprising mineral fibers or natural organic fibers bound by an organic binder obtained by curing or cross-linking a sizing composition containing a lignin, which is potentially oxidized, and a non-polymeric polycarboxylic organic acid. The invention also relates to the insulating products obtained by such a method.

The production of insulating products based on mineral fibers, notably based on mineral wool, generally comprises a step of manufacturing glass fibers or rock fibers through a centrifugation process. On their path between the centrifugation device and the fiber collection belt, an aqueous sizing composition, also referred to as aqueous binder composition, is sprayed onto the fibers while they are still hot, and the composition then undergoes a polymerization reaction, at temperatures generally greater than 100° C.

For several years now, the use of various thermosetting resins, as binders, contained in the sizing compositions, has made it possible to bind the mineral fibers and improve the mechanical performance of the resulting insulation products. The thermosetting resins most commonly used for the manufacture of insulating products based on mineral wool are phenolic resins of resol type. Besides their good crosslinking capacity under the aforementioned thermal conditions, these resins are water-soluble, have good affinity for the mineral fibers, by virtue in particular of the presence of silane, and are relatively inexpensive.

The commonest resols are obtained by condensation of phenol and formaldehyde, in the presence of a basic catalyst. Ultimately, these resols contain a certain proportion of unreacted monomers, in particular formaldehyde, whose presence is undesirable on account of its known harmful effects.

For this reason, resol-based resins are generally treated with urea which reacts with the free formaldehyde, trapping it in the form of nonvolatile urea-formaldehyde condensates. Moreover, the presence of urea in the resin gives a certain economic advantage owing to its low cost, as it can be introduced in relatively large amounts without affecting the usage qualities of the resin, in particular without adversely affecting the mechanical performance of the finished product, which lowers the total cost of the resin considerably.

It has nevertheless been observed that, under the temperature conditions to which the layer of mineral wool is subjected in order to obtain cross-linking of the resin, urea-formaldehyde condensates are unstable; they decompose giving formaldehyde and urea again, the latter being degraded at least partially into ammonia, and released into the factory's atmosphere and must be subject to collection procedures in order to reduce the impact thereof on the environment. Solutions for replacing formaldehyde-based resins in sizing compositions have therefore been developed.

The Applicant proposed, in their applications WO2010/029266 and WO2013/014399, sizing compositions based on hydrogenated sugars, also known as sugar alcohols, for binding mineral fibers. These reagents have very good thermal stability and give the final product good mechanical performance.

Binders devoid of formaldehyde containing both hydrogenated sugars and reducing or non-reducing sugars have been disclosed, respectively, in applications WO2013/021112 and WO2015/159012 in the Applicant's name for binding mineral fibers. However, these sugar-based resins have shown little reactivity and stability for binding natural organic fibers.

In order to bind natural organic fibers, and in particular to obtain insulating products with a density of less than 250 kg/m³, it is known to use binders obtained after curing or cross-linking of sizing compositions comprising polyisocyanates. Among the polyisocyanates most commonly used in the wood fiber industry, mention may be made of poly (methylene diphenyl isocyanate) (pMDI, CAS number 9016-87-9) which is a technical grade blend containing 30-80% of MDI (methylene diphenyl isocyanate) and higher molecular weight homologues of formula

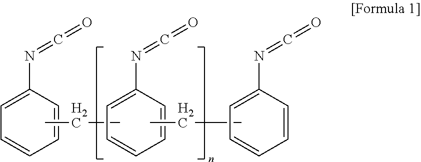

In order to ensure good wetting of natural organic fibers by hydrophobic pMDI, it is generally first necessary to subject the fibers to drying so as to reduce their water content to a value less than or equal to 6% by weight, in particular of between 2-6% by weight (see WO2008/144770).

Proposed more recently are emulsifiable pMDIs (EMDI), which are either mixtures of pMDI with non-ionic surfactants free of labile hydrogens capable of reacting with isocyanate functions (see for example EP0516361), or mixtures of pMDI and a low percentage of pMDI functionalized with hydrophilic chains, for example polyethoxylated chains, to stabilize the emulsion.

The use of pMDI in the form of aqueous emulsions allows a regular distribution of the binder on natural organic fibers without preliminary drying, which constitutes a significant energy saving.

However, the use of polyisocyanate-based binders, even in the form of aqueous pMDI emulsions, constitutes a major problem in terms of noxiousness at the board manufacturing site, due to the presence of polyisocyanates. Furthermore, polyisocyanates are highly reactive and expensive raw materials.

The Applicant has therefore sought a method for manufacturing both mineral fiber-based insulation products and natural organic fiber-based insulating products that uses the same type of organic binder, in other words, the same sizing composition that enables both mineral fibers and natural organic fibers to be bound after curing; such sizing composition preferably being biosourced, needing to be low noxious, low cost, and having good cross-linking ability and being able to be uniformly distributed over any of the aforementioned fibers and enabling insulating products with good mechanical properties to be obtained. The desired sizing composition must also have the advantage of not or barely polymerizing/cross-linking before passing through the appropriate heating device, and/or polymerizing/cross-linking rapidly upon passing through the appropriate heating device.

In the course of this research, the inventors discovered that a sizing composition comprising the specific combination of:
at least one lignin, potentially oxidized, and
at least one non-polymeric polycarboxylic organic acid,
   offered the desired advantages or properties.

Thus, the object of the present application is more precisely a method for manufacturing an insulation product comprising mineral fibers or natural organic fibers bound by an organic binder, comprising the following steps:
(a) applying a sizing composition to said mineral fibers or said natural organic fibers,
(b) forming an assembly of said mineral fibers or said natural organic fibers,
(c) heating the assembly of said mineral fibers or said natural organic fibers until said sizing composition has cured, characterized in that said sizing composition comprises:
at least one lignin, which is potentially oxidized, and
at least one non-polymeric polycarboxylic organic acid.

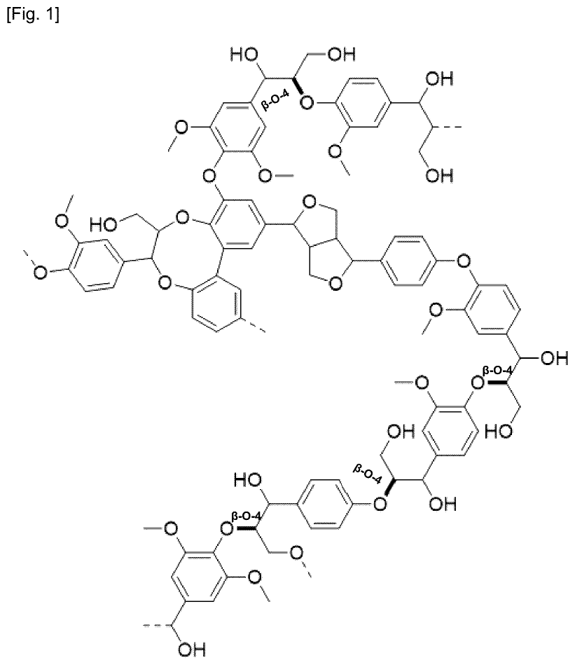

The lignin according to the invention is a lignin extracted from so-called “native” lignin, a biomolecule belonging to a family of polyphenolic polymeric macromolecules (broadly the tannin family), which is one of the main components of wood along with cellulose and hemicellulose. FIG. 1 [FIG. 1] shows a possible structure of native lignin. Native lignin is a macromolecule with a molar mass well in excess of 10,000 g·mol⁻¹, and is not soluble in water. Native lignin is found mainly in vascular plants and some algae. The main functions thereof are to provide rigidity, waterproofing and high resistance to decomposition. All vascular plants, whether woody or herbaceous, produce lignin. Quantitatively, native lignin content is 3 to 5% in leaves, 17 to 24% in herbaceous stems, 18 to 33% in woody stems (18 to 25% of hardwood in angiosperm trees, 27 to 33% of softwood in gymnosperm trees). It is less common in annual plants than in perennial plants, but is very common in trees. Native lignin is mainly located between the cells, but significant amounts are found within them. Although lignin is a complex three-dimensional hydrophobic network, the basic unit is essentially a monolignol unit. After cellulose (constituting 35 to 50% of terrestrial plant biomass) and hemicellulose (30 to 45%), lignin (15 to 25%) is the third most abundant family of compounds in plants and terrestrial ecosystems, where dead or living plant biomass dominates.

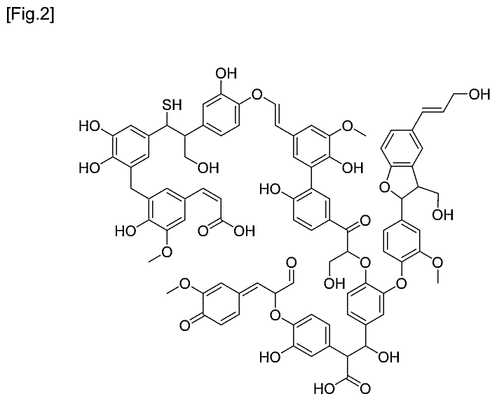

The lignin, according to the invention, is a macromolecule, one possible structure of which is shown in FIG. 2 [FIG. 2]. The lignin, according to the invention, is extracted by cleavage of the β-O-4 ether bonds of the native lignin and therefore has a lower molar mass than the native lignin from which it is derived, that is, an average molar mass of less than 10,000 g·mol⁻¹, preferably a molar mass of between 1,000 g·mol⁻¹ and 9,000 g·mol⁻¹.

The lignin, according to the invention, can be selected from alkaline lignins, also known as kraft lignins, lignosulfonates, organosolv lignins, sodium lignins, lignins from the biorefining process of lignocellulosic raw materials, or a mixture thereof. The four groups of lignins available on the market are alkaline or kraft lignins, lignosulfonates, organosolv lignins (extracted lignins and sodium lignins). The fifth group is the so-called biorefinery lignin, which is a little different in that it is not described by its extraction method, but rather by the origin of the method, for example, by biorefining, and can therefore be similar to or different from any of the other groups mentioned. The lignin, according to the invention, is preferably alkaline lignin, also known as kraft lignin.

FIG. 2 [FIG. 2] shows a possible structure of lignin according to the invention. The reactive functional group present in large quantities in a typical lignin is the hydroxyl group, which is either an aromatic hydroxyl group or an aliphatic hydroxyl group, that is a primary alcohol function or a secondary alcohol function (a secondary alcohol function being less reactive than a primary alcohol function). It is known that the hydroxyl groups of lignin can react with cross-linking agents such as isocyanates or epoxides, amines or aldehydes, leading to a cross-linked lignin structure, according to different cross-linking mechanisms. However, these cross-linking agents are of less interest due to their toxicity (isocyanates, amines, formaldehyde) and/or cost (epoxides, amines, aldehydes other than formaldehyde).

Thus, the inventors discovered that non-polymeric polycarboxylic acids, which are themselves low in toxicity, could cross-link the lignin. Furthermore, they discovered that these non-polymeric polycarboxylic acids, as lignin cross-linking agents could be used to bind both mineral and natural organic fibers after curing or cross-linking of these constituents; also resulting in insulating products with equally good or even better mechanical performance, compared to the use of other known cross-linking agents such as formaldehyde or isocyanates.

In this application, the term “non-polymeric” polycarboxylic organic acid

is understood to mean a polycarboxylic organic acid which is not a macromolecule consisting of the assembly of monomers with a molar mass of between 90 g·mol⁻¹ and 350 g·mol⁻¹, linked together by covalent bonds in a repetitive manner. Thus, in the present application, the sizing composition is preferably free of polymeric polycarboxylic organic acid. The non-polymeric polycarboxylic organic acid according to the invention may be chosen from dicarboxylic acids, in particular oxalic acid, malonic acid, succinic acid, glutaric acid, adipic acid, pimelic acid, suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid and derivatives thereof, in particular containing at least one boron or chlorine atom, tetrahydrophthalic acid and derivatives thereof, in particular containing at least one chlorine atom, isophthalic acid, terephthalic acid, mesaconic acid and citraconic acid, tricarboxylic acids, in particular citric acid, tricarballylic acid, 1,2,4-butanetricarboxylic acid, aconitic acid, hemimellitic acid, trimellitic acid and trimesic acid; and tetracarboxylic acids, in particular 1,2,3,4-butanetetracarboxylic acid and pyromellitic acid. Even more preferably, the non-polymeric polycarboxylic organic acid is selected from maleic acid, succinic acid, glutaric acid, itaconic acid and citric acid. Even more preferentially, the non-polymeric polycarboxylic organic acid is a tricarboxylic acid, in particular citric acid.

In other words, it was surprisingly found by the inventors that lignin, which is an inexpensive, non-toxic and low-corrosive biosourced material, could, in combination with a low-toxic, non-polymeric polycarboxylic organic acid, bind mineral fibers or natural organic fibers, after curing or cross-linking of these constituents; and enable the manufacture of insulating products with mechanical properties as good as, or even better than, the known binders mentioned above.

In one embodiment of the invention, the lignin is diluted in water and the pH adjusted to between 6.5 and 10.5, preferably between 8 and 9, before the non-polymeric polycarboxylic organic acid is added. This pH range enables a more homogeneous deposition of the sizing composition on the fibers, which consequently has the advantage of improving the mechanical properties of the insulating products obtained.

Preferably, the sizing composition comprises from 25% to 85% by weight of at least one lignin, and more preferentially from 40% to 80% by weight, and even more advantageously from 50% to 75% by weight, based on the total dry weight of the composition.

Preferably, the sizing composition comprises 15% to 75% by weight of at least one non-polymeric polycarboxylic organic acid, and more preferentially 20% to 60% by weight, and even more advantageously 25% to 50% by weight, based on the total dry weight of the composition.

In another preferred embodiment of the method of the invention, the lignin contained in the sizing composition in combination with the non-polymeric polycarboxylic organic acid is an oxidized lignin. In this embodiment, the amount of oxidized lignin is between 50% and 85% by weight, preferably between 55% and 80% by weight, and more preferentially between 60% and 75% by weight, based on the total dry weight of the sizing composition, and the oxidized lignin comprises a percentage of carboxylic acid function between 2% and 20%, preferably between 5% and 15%, and a percentage of primary alcohol function between 2% and 20%, preferably between 5% and 15%. Said percentages of carboxylic acid function and primary alcohol function present on the oxidized lignin are measured by infrared spectroscopy; by calculating the ratio of the intensity of the peaks of the C—O bond of the carboxylic acid function (C—OOH) and respectively that of the primary alcohol function (C—OH) of the oxidized lignin compared to the sum of the intensity of the peaks of the C—O bond of all the functions present on the oxidized lignin, all the peaks being located between 1000 cm⁻¹ and 1300 cm⁻¹. All the functions present on the oxidized lignin with a C-O bond are the following: primary and secondary alcohol functions (C-OH); aromatic hydroxyl functions (Ar—OH), acid functions (C—OOH); aromatic ether functions (Ar—OC), aliphatic and cycloaliphatic ether functions (C—OC), and methyl ether functions (C—OCH₃).

The use of oxidized lignin (compared to non-oxidized lignin) has the advantage of reducing the amount of non-polymeric polycarboxylic organic acid to be added to the sizing composition for binding the mineral fibers or organic fibers. Thus, in this particular embodiment, the amount of non-polymeric polycarboxylic organic acid is between 15% and 50% by weight, preferably between 20% and 45% by weight, and more preferentially between 25% and 40% by weight, based on the total dry weight of the sizing composition.

Indeed, in the sizing composition comprising the combination of at least one oxidized lignin and at least one non-polymeric polycarboxylic organic acid, the carboxylic acid groups present on the oxidized lignin obtained by splitting the macromolecule and then oxidizing the secondary aliphatic hydroxyl groups of the starting lignin will react with some of the aliphatic hydroxyl groups of the oxidized lignin (in particular the primary alcohol functions) during the heating stage of the fiber assembly, initiating self-crosslinking of the oxidized lignin and the other aliphatic hydroxyl groups of the oxidized lignin remaining will then react with the carboxylic acid groups of the non-polymeric polycarboxylic organic acid added as a cross-linking agent to complete the cross-linking of said oxidized lignin.

In addition, the sizing composition according to the invention may be formaldehyde-free. “Formaldehyde-free” in the present application is understood to mean a formaldehyde content of less than 2000 ppm in a sizing composition according to the invention.

The sizing composition is an aqueous composition which can have a dry matter content of between 0.5% and 50% by weight, preferably between 3% and 30% by weight, and more preferentially between 4% and 20% by weight.

The aqueous sizing composition is, in turn, applied to the mineral fibers or natural organic fibers in a quantity of between 2% and 20% by weight, preferably between 5% and 15% by weight, said quantity being expressed as dry matter based on the weight of the mineral fibers or natural organic fibers, in order to impart the desired mechanical properties on the insulating product.

In a preferred embodiment of the method of the invention, step (a) of applying the sizing composition to the mineral fibers or natural organic fibers can be carried out by spraying, particularly by means of spray nozzles, or by roller coating or by impregnation.

According to the invention, the mineral fibers are preferentially mineral wools and even more preferentially glass, rock or slag wools, or mixtures thereof. In particular, when the mineral fibers are mineral wools, they may contain a composition corresponding to the following formulation, as a percentage by weight:
SiO₂: between 30 and 50%, preferably between 35 and 45%,
Na₂O: between 0 and 10%, preferably between 0.4 and 7%,
CaO: between 10 and 35%, preferably between 12 and 25%,
MgO: between 1 and 15%, preferably between 5 and 13%,
CaO+MgO: between 11 and 40% in total,
Al₂O₃: between 10 and 27%,
K₂O: between 0 and 2%, preferably between 0 and 1%,
Iron oxide: between 0.5 and 15%, preferably between 3 and 12%, other oxide(s): between 0 and 5% in total, preferably less than 3%, the remainder being composed of unavoidable impurities.

Mineral fibers can be glass fibers or rock fibers, in particular basalt (or wollastonite). And more particularly, the mineral fibers according to the invention are fibers of aluminosilicate glass, notably aluminosilicate glass fibers comprising aluminum oxide, Al₂O₃, in a fraction by weight of between 14% and 28%. In another embodiment, the mineral fibers may be glass fibers containing a composition corresponding to the following formulation, as a percentage by weight:
SiO₂: between 50 and 75%, preferably between 60 and 70%,
Na₂0: between 10 and 25%, preferably between 10 and 20%,
CaO: between 5 and 15%, preferably between 5 and 10%,
MgO: between 1 and 10%, preferably between 2 and 5%,
CaO and MgO together representing preferably between 5 and 20%,
B₂O₃: between 0 and 10%, preferably between 2 and 8%,
Al₂O₃: between 0 and 8%, preferably between 1 and 6%,
K₂O: between 0 and 5%, preferably between 0.5 and 2%,
Na₂O and K₂0 together representing preferably between 12 and 20%,
Iron oxide: between 0 and 3%, preferably less than 2%, even more preferably less than 1%,
other oxide(s): between 0 and 5% by weight in total, preferably less than 3% in total,
the remainder being composed of unavoidable impurities.

The diameter of the mineral fibers is advantageously between 0.1 and 25 μm.

The diameter of the natural organic fibers is advantageously between 5 and 100 μm, preferably between 10 and 50 μm, and the length of these fibers is in particular between 0.1 and 900 mm, and more particularly between 10 and 120 mm. According to the invention, the natural organic fibers are advantageously fibers which are not thermoplastic, and which are naturally present in the biomass and may have undergone mechanical and/or chemical treatments. Said fibers originate from plant sources and are advantageously selected from cotton and lignocellulosic fibers. Lignocellulosic fibers are understood to mean fibers of plant origin based on lignocellulosic material, that it to say comprising cellulose, hemicellulose and lignin. Lignocellulosic fibers include wood fibers, and fibers from other plants for example hemp, flax, sisal, cotton, jute, coconut, raffia, abaca fibers, or even cereal straw or rice straw.

The term “lignocellulosic fibers” as used in the present application does

not include lignocellulosic materials having undergone thermomechanical or chemical treatments for the manufacture of paper pulp.

The lignocellulosic fibers used in the present invention therefore have simply undergone a mechanical comminution treatment intended to reduce and/or control the dimension of the fibers.

Lignocellulosic fibers are preferably softwood, particularly pine, fibers obtained by mechanical defibration. Their diameter is advantageously between 10 and 70 μm, preferably between 30 and 50 μm, and their length ranges from 0.1 to 100 mm, preferably from 0.5 to 50 mm, particularly from 1 to 10 mm.

The application of the sizing composition a) preferably precedes the step (b) of forming an assembly of mineral fibers or natural organic fibers, during which the sized fibers are brought together, before being heated consecutively or extemporaneously to cure the sizing composition thus forming the organic binder that binds the fibers.

Thus, step b) of forming an assembly of mineral fibers or natural organic fibers, which can also be called the step of shaping the set of fibers, can be carried out by molding and/or compression. The mold used for molding the products must be made of a material capable of withstanding the temperature of the heating step. It must also have a structure that allows the hot air from the curing oven to easily penetrate the molded product. The mold can for example consist of a box-shaped metal screen. The metal-screen box is preferably filled with a volume of loose fibers that is greater than its capacity and is then closed by a metal-screen cover. The fibers are thus more or less compressed depending on the excess filling volume. This excess filling volume of the box by the fibers is for example comprised between 10% and 150%, preferably between 15 and 100% and in particular between 20 and 80%.

When the method of the present invention is a continuous method, the step b) of forming an assembly of fibers can be done for example by compression by means of a roller located at the entrance to the curing oven on a conveyor.

Furthermore, fibers can be assembled as:
flexible fiber mats that can be rolled up, compressed or folded,
fiberboards or plates, which are denser and more rigid than rollable mats,
molded fiber-based products, for example linings for pipes or ducts,
woven or non-woven textiles, such as non-woven mats made of glass or organic fibers.

In a particular embodiment of the method according to the invention, the fibers are natural organic fibers impregnated with an aqueous sizing composition, and said method further comprises, between step a) and step b), a fiber drying step whose purpose is to evaporate sufficient water to render the sized or non-sized fibers substantially non-sticky. In another embodiment, the drying step can be performed prior to step a). This drying step can be carried out by heating, for example in a temperature-controlled ventilated oven or else using a steam heating press. It is important to ensure that the drying does not heat the natural organic fibers to an excessively high temperature that results in the softening of the dried sizing composition, or even in the onset of cross-linking of the components of the sizing composition. A heating temperature close to the boiling point of water is generally enough. Drying of the fibers impregnated with aqueous sizing composition is thus preferably carried out by heating to a temperature of between 75° C. and 150° C., for a duration of between 1 second and 10 seconds. The natural organic fibers obtained after the drying step are surrounded by a sheath of dried sizing composition.

Step (c) of heating the assembly of mineral fibers or natural organic fibers according to the method of the invention is preferably carried out at a temperature of between 100° C. and 250° C. for a period of time of between 1 minute and 20 minutes, preferably in a temperature-regulated enclosure or a steam press. A temperature-regulated enclosure may be a forced air oven wherein temperature-controlled hot gases are introduced into one or more compartments, or a heating mold with fluid circulation or resistive heater. During this step of heating the assembly of said mineral fibers or said natural organic fibers, the constituents of the sizing composition (according to the invention) cure/or cross-link/polymerize to form an insoluble organic binder.

In another particular embodiment of the method according to the invention, the fibers are mineral fibers and after step (c) of heating the assembly of said mineral fibers until the sizing composition has cured, the mineral fiber assembly has a loss on ignition (LOI) of between 1% and 20%, preferably between 1% and 15% by weight.

The invention also relates to an insulating product that can be obtained by the method as described above. Said insulating product obtained consequently comprises mineral fibers or natural organic fibers, bonded with a binder obtained by curing or cross-linking a sizing composition (as described above) comprising a lignin, optionally oxidized, and a non-polymeric polycarboxylic organic acid. The insulating product obtained has good mechanical properties. The insulating product can have a thickness of between 10 and 300 mm, preferably between 35 and 240 mm, measured according to EN 823:2013 and a density of between 30 and 200 kg/m³, preferably between 35 and 180 kg/m³. The insulating product obtained can be used to make panels for the external insulation of buildings. The insulating product obtained can notably be a net of mineral fibers, in particular glass or rock fibers.

### EXAMPLES

### Example 1:

Aqueous sizing compositions are prepared comprising the constituents listed in Table 1, each expressed as a percentage by weight, based on the total dry weight of each composition.

Composition 1, outside the invention (that is, a comparative sample), is prepared by mixing kraft lignin A with water. Compositions 2 to 4, according to the invention, are prepared by mixing a first solution containing lignin A dissolved in water with a second solution containing a particular non-polymeric carboxylic organic acid which is dissolved in water. Compositions 5 and 5 bis, outside the invention (that is, a comparative sample), are prepared by successively adding to a container 48 parts by weight of maltitol (as hydrogenated sugar), 52 parts by weight of citric acid, and 5 parts by weight of sodium hypophosphite, the sodium hypophosphite (catalyst) under vigorous agitation until the constituents are completely dissolved.

All sizing compositions 1 to 5 and 5 bis contain 90% by weight of water

and 10% by weight of dry matter. All the compositions are used to form glass-fiber based insulating products.

Two stacked pieces (60 mm×10 mm×0.250 mm) of non-woven glass fiber paper are impregnated respectively with each of the aqueous sizing compositions, then the impregnated glass fiber papers are cured at a temperature of 150° C. for 4 minutes (for samples 1 to 5) or 210° C. for 10 minutes (for sample 5bis).

The conservation modulus of the samples is measured using the three-point bend test during curing by dynamic mechanical thermal analysis (DMTA) using a “TA Instruments RSA-G2 Analyzer” device.

The operating parameters of the measuring device are as follows:
Temperature: 25° C.
Poisson's ratio: 0.45
Duration of oscillatory mechanical stress: 120 seconds

Oscillation frequency: 1.0 Hz,
Deformation: 0.1%
Sampling rate: 10 points/second.

Table 1 below shows the conservation modulus of glass fiber papers obtained after each of the sizing compositions is cured. Each conservation

modulus value is the calculated average of two to four individual measurement values.

### Results

TABLE 1

| | | Conservation |
|---|---|---|
| Specimen | Glass fiber sizing composition | modulus |
| 1 (comp.) | 100% lignin A | 0.92 GPa |
| 2 (inv.) | 50% lignin A + 50% succinic acid | 1.18 GPa |
| 3 (inv.) | 50% lignin A + 50% glutaric acid | 2.69 GPa |
| 4 (inv.) | 50% lignin A + 50% citric acid | 2.74 GPa |
| 5 (comp.) | 100% hydrogenated sugar-based resin | 0.26 GPa |
| 150° C., 4 min | | |
| 5 bis (comp.) | 100% hydrogenated sugar-based resin | 1.18 GPa |
| 210° C., 10 min | | |

It can be seen that glass fiber papers prepared according to the invention, that is using sizing compositions 2 to 4 comprising the combination of lignin A and a non-polymeric polycarboxylic organic acid, exhibit a higher conservation modulus (between 1.18 GPa and 2.74 GPa) than glass fiber papers prepared using sizing composition 1 (0.92 GPa) which comprises lignin alone (that is, without a cross-linking agent). Furthermore, a higher conservation modulus is obtained for insulating products prepared using the sizing composition comprising lignin A and citric acid (composition 4). It can also be seen that the glass fiber papers prepared in accordance with the invention (compositions 2 to 4) exhibit:
a higher conservation modulus than that of glass fiber papers obtained using a well-known thermosetting resin such as hydrogenated sugar-based resin (composition 5, comparative example), or
a conservation modulus of the same order of magnitude as that of glass fiber papers obtained using hydrogenated sugar-based resin, when the temperature and duration of the curing step are increased (see example 5 bis).

Aqueous sizing compositions are prepared comprising the constituents listed in Table 2, each expressed as a percentage by weight, based on the total dry weight of each composition.

Composition 6 (comparative example) is prepared by emulsifying emulsifiable poly (methylene diphenyl isocyanate) (pMDI) with water. Compositions 7 and 8, according to the invention, are prepared by mixing a first solution containing lignin A dissolved in water with a second solution containing succinic acid dissolved in water. Composition 9 (comparative example) is prepared by mixing a first solution containing lignin A dissolved in water with a second solution containing ethylene glycol diglycidyl ether (an epoxide) dissolved in water.

The sizing composition 6 contains 40% by weight of water and 60% by weight of dry matter. Sizing compositions 7 to 9 contain 90% by weight of water and 10% by weight of dry matter.

For each test, wood fibers are impregnated with an aqueous sizing composition. The amount of aqueous sizing compositions 6, 8 and 9 deposited on the wood fibers is equal to 7% by weight expressed as dry matter relative to the weight of the wood fibers. The amount of aqueous sizing composition 7deposited on the wood fibers is equal to 10% by weight expressed as dry matter relative to the weight of the wood fibers.

The impregnated wood fibers are then uniformly deposited in a steel mold with an open cavity measuring 60 mm×10 mm×12 mm. Steel bars measuring 60 mm×10 mm×10 mm are placed on top of the wood fibers, and the whole assembly is heated for 4 minutes in a thermostatic press at 150° C. and 10 bar of pressure. The molds are then allowed to cool to room temperature before removing the specimens of lignocellulosic fiber formed (60 mm×10 mm×2 mm).

The wood fiber specimens thus obtained have a density of around 180 kg/m³.

The conservation modulus in flexion (three-point flexion) is determined for each specimen by dynamic mechanical thermal analysis (DMTA) using a “TA Instruments RSA-G2 Analyzer” device. The samples are first dried for several hours in a desiccator under dynamic vacuum (20 mbar). The operating parameters of the measuring device are the same as those mentioned above.

Table 2 below shows the conservation modulus of wood fiber specimens obtained after each of the sizing compositions is cured. Each conservation modulus value is the calculated average from two to four individual measurement values.

### Results

TABLE 2

| | | Quantity of | conservation | |
|---|---|---|---|---|
| Specimen | Wood fiber sizing composition | composition | modulus | |
| 6 (comp.) | 100% poly(methylene diphenyl | 7% | 105 | MPa |
| | isocyanate) | | | |
| 7 (inv.) | 50% lignin A + 50% succinic | 10% | 107.6 | MPa |
| | acid | | | |
| 8 (inv.) | 50% lignin A + 50% succinic | 7% | 50.6 | MPa |
| | acid | | | |
| 9 (comp.) | 50% lignin A + 50% ethylene | 7% | 30.4 | MPa |
| | glycol diglycidyl ether | | | |

It can be seen that wood fiber specimens prepared according to the invention, that is, using sizing composition 8 comprising the combination of lignin and succinic acid (as lignin cross-linking agent), have a higher conservation modulus (50.6 GPa) than wood fiber specimens prepared using sizing composition 9 (comparative example) whose lignin cross-linking agent is not a non-polymeric organic carboxylic acid but an epoxide. A conservation modulus of the same order of magnitude is obtained for wood fiber specimens prepared using the known sizing composition 6 and the sizing composition 7 according to the invention with a higher quantity of sizing composition on said fibers.

In conclusion, Tables 1 and 2 show that lignin in combination with a non-polymeric organic carboxylic acid can be used to bind both mineral and natural organic fibers, and can also be used to obtain insulating products with mechanical properties as good as, or even better than, those obtained using known sizing compositions.

### Example 2:

Lignin B is taken and the quantity of carboxylic acid functions and primary alcohol functions present on said lignin is determined by infrared spectroscopy by measuring the intensity of the C—OOH bond peak of the carboxylic acid function at around 1190 cm⁻¹ and that of the C—OH bond of the primary alcohol function at around 1040 cm⁻¹, compared to the sum of the intensity of the C—O bond peaks, located between 1000 cm⁻¹ and 1300 cm⁻¹, of all the functions present on said lignin B. All the functions present on lignin B with a C—O bond are the following: primary and secondary alcohol functions (C—OH); aromatic hydroxyl functions (Ar—OH), acid functions (C—OOH); aromatic ether functions (Ar—OC), aliphatic and cycloaliphatic ether functions (C—OC), and methyl ether functions (C—OCH₃).

Then, the same measurements are carried out on lignin B, which is first oxidized under the following conditions: in aqueous solution at pH≥13 with H₂O₂+FeCl₃ as the oxidizing agent for 120 minutes at 95° C. In this case, all the functions present on oxidized lignin B with a C—O bond are the following: primary and secondary alcohol functions (C—OH); aromatic hydroxyl functions (Ar—OH), acid functions (C—OOH); aromatic ether functions (Ar—OC), aliphatic and cycloaliphatic ether functions (C—OC) and methyl ether functions (C—OCH₃).

Two sizing compositions 10 and 11 are then prepared respectively by mixing lignin B and oxidized lignin B dissolved in water with succinic acid dissolved in water. These sizing compositions are deposited on wood fibers in order to produce wood fiberboard specimens according to the method described in example 1. The conservation modulus in flexion of said wood fiber specimens obtained is measured by dynamic mechanical thermal analysis (DMTA) as explained in example 1.

Table 3 shows the results obtained for each of the sizing compositions.

TABLE 3

| | Lignin B composition | | Sizing composition | | conservation |
|---|---|---|---|---|---|
| | Primary C—OH | Acid C—OOH | | Succinic | modulus |
| | function | function | Lignin | acid | in (MPa) |
| Lignin B | 14% | <1% | 50% | 50% | 50.6 |
| Composition 10 | | | | | |
| Lignin B | 14% | <1% | 62.5% | 37.5% | 25.0 |
| Composition 10 | | | | | |
| Oxidized lignin B | 10% | 11% | 62.5% | 37.5% | 49.5 |
| Composition 11 | | | | | |
| Oxidized lignin B | 10% | 11% | 50% | 50% | 23.8 |
| Composition 11 | | | | | |

It can be seen that the use of oxidized lignin B, which comprises more carboxylic acid functions than “non-oxidized” lignin B (11% for oxidized lignin versus <1% for “non-oxidized” lignin) reduces the amount of succinic acid to be added (37.5% when oxidized lignin is used versus 50% when “non-oxidized” lignin is used) to obtain a sizing composition whose final insulating product has an equivalent conservation modulus.

1. A method for manufacturing an insulation product comprising mineral fibers or natural organic fibers bound by an organic binder, comprising:
(a) applying a sizing composition to said mineral fibers or said natural organic fibers,
(b) forming an assembly of said mineral fibers or said natural organic fibers,
(c) heating the assembly of said mineral fibers or said natural organic fibers until said sizing composition has cured to form the organic binder,
wherein said sizing composition comprises:
at least one lignin, potentially oxidized, and
at least one non-polymeric polycarboxylic organic acid.

2. The method according to claim 1, wherein the lignin is chosen from alkaline lignins, also known as Kraft lignins, lignosulfonates, organosolv lignins, sodium lignins, lignins from the biorefining process of lignocellulosic raw materials or a mixture thereof.

3. The method according to claim 1, wherein an amount of lignin is between 25% and 85% by weight, based on the a total dry weight of the sizing composition.

4. The method according to claim 3, wherein an amount of non-polymeric polycarboxylic organic acid is between 15% and 75% by weight, based on the total dry weight of the sizing composition.

5. The method according to claim 1, wherein the lignin is an oxidized lignin and an amount thereof is between 50% and 85% by weight based on the a total dry weight of the sizing composition, and wherein the oxidized lignin comprises a percentage in carboxylic acid function of between 2% and 20%, and a percentage in primary alcohol function of between 2% and 20%.

6. The method according to claim 5, wherein the amount of non-polymeric polycarboxylic organic acid is between 15% and 50% by weight based on the total dry weight of the sizing composition.

7. The method according to claim 1, wherein the non-polymeric polycarboxylic organic acid is chosen from dicarboxylic acids, tricarboxylic acids; and tetracarboxylic acids.

8. The method according to claim 1, wherein the mineral fibers are glass fibers or rock fibers or slag fibers, or mixtures thereof.

9. The method according to claim 1, wherein the natural organic fibers are chosen from fibers from wood, hemp, flax, sisal, cotton, jute, coconut, raffia, abaca fibers, or even cereal straw or rice straw.

10. The method according to claim 1, such that the application of said sizing composition of step a) on the mineral fibers or natural organic fibers is carried out by spraying, by roller coating or by impregnation.

11. The method according to claim 1, wherein the assembly of mineral fibers or natural organic fibers in step b) is a fiber mat, a fiber board or panel, a fiber-based molded product, or a woven or non-woven textile.

12. The method according to claim 1, wherein step c) comprises the heating of said assembly of fibers at a temperature of between 100° C. and 250° C. for a period of time of between 1 minute and 20 minutes.

13. An insulating product obtained by a method according to claim 1, comprising mineral fibers or natural organic fibers and an organic binder obtained by curing a sizing composition comprising at least one lignin, which is potentially oxidized, and a non-polymeric polycarboxylic organic acid.

14. The insulating product according to claim 13, wherein the insulating product is a net of mineral fibers.

15. The method according to claim 3, wherein the amount of lignin is between 40% and 80% by weight based on the total dry weight of the sizing composition.

16. The method according to claim 4, wherein the amount of non-polymeric polycarboxylic organic acid is between 20% and 75% by weight based on the total dry weight of the sizing composition.

17. The method according to claim 5, wherein the amount of oxidized lignin is between 55% and 80% by weight based on the total dry weight of the sizing composition.

18. The method according to claim 5, wherein the oxidized lignin comprises a percentage in carboxylic acid function of between 5% and 15%, and a percentage in primary alcohol function of between 5% and 15%.

19. The method according to claim 6, wherein the amount of non-polymeric polycarboxylic organic acid is between 20% and 45% by weight based on the total dry weight of the sizing composition.

20. The method according to claim 7, wherein the dicarboxylic acids are oxalic acid, malonic acid, succinic acid, glutaric acid, adipic acid, pimelic acid, suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid and derivatives thereof, optionally containing at least one boron or chlorine atom, tetrahydrophthalic acid and derivatives thereof optionally containing at least one chlorine atom, isophthalic acid, terephthalic acid, mesaconic acid and citraconic acid, or wherein the tricarboxylic acids are citric acid, tricarballylic acid, 1,2,4-butanetricarboxylic acid, aconitic acid, hemimellitic acid, trimellitic acid and trimesic acid, or wherein tetracarboxylic acids are 1,2,3,4-butanetetracarboxylic acid and pyromellitic acid.
